(19) United States
(12) Patent Application Publication
(10) Pub. No.: US 2008/0055483 A1
(43) Pub. Date: Mar. 6, 2008

(54) Method for detecting a program deviation period during a television broadcast

(76) Inventors: Wei-Hung Huang, Hsinchu City (TW); Hsing-Ju Wei, Keelung City (TW)

Correspondence Address: NORTH AMERICA INTELLECTUAL PROPERTY CORPORATION, P.O. BOX 506, MERRIFIELD, VA, 22116, US

(21) Appl. No.: 11/846,526

(22) Filed: Aug. 29, 2007

Related U.S. Application Data
(63) Continuation-in-part of application No. 11/469,874, filed on Sep. 3, 2006.

(51) Int. Cl. H04N 5/14

(52) U.S. Cl. 348/701

(57) ABSTRACT

A method for detecting a program deviation period during a television broadcast having a main audio program and a secondary audio program includes: receiving the main audio program; receiving the secondary audio program; converting the audio programs into a main channel and a secondary channel; calculating a similarity value between the main channel and the secondary channel within a candidate period; and determining whether the candidate period is the program deviation period according to the calculated similarity value.

### CROSS REFERENCE TO RELATED APPLICATIONS

This continuation-in-part application claims the benefit of U.S. patent application Ser. No. 11/469,874, filed on Sep. 3, 2006 and included herein by reference.

### BACKGROUND

The present invention relates to television broadcasting, and more specifically, to a method for detecting a program deviation period during a television broadcast.

Since the inception of television, and mainstream television broadcasting in the mid 1950s, television programming has become an everyday staple in America and around the world alike. The ability to watch and enjoy various programs, including news, variety shows, and movies, allowed viewers an escape from their everyday lives. While North American over-the-air broadcasting was originally free of direct marginal cost to the consumer, broadcasts began to eventually generate revenue through the form of on-air advertising as a form of compensation. Eventually, these advertisements, or commercials, offered companies a chance to purchase a limited time slot of on-air programming in an attempt to garner publicity and sell their product.

Presently, commercials are an expected everyday part of television programming. While the look and style of commercials have changed over the years, their main purpose has not. In fact, the frequency and duration of commercials have even increased throughout recent years. While this is good news for an advertiser wanting airplay to sell their product, this becomes a nuisance for a viewer that is interested in watching the television program only, and not the commercials embedded within its airplay.

Therefore, a need has emerged for detecting commercials during television programming. Although this problem has been considered for some time, the results and complexity of such solutions remain varied. Prior art solutions may incorporate techniques such as: detecting a frequency of a scene change, detecting a degree of continuity in the periodicity of a provided audio signal, and detecting a repetition of a video signal.

FIG. 1 is an example of a commercial detection unit according to the prior art. This commercial detector (Suito et al., U.S. Pat. No. 6,459,735) operates on the basis of a quiet section (soundless section) and a scene change point. A commercial characteristic quantity detector judges whether a commercial candidate section has various characteristics of commercials. Many elements, including video signals, audio signals, and multiplex mode signals are incorporated into this complicated approach. Although operable, FIG. 1 illustrates that several complex components and hardware devices are required in producing this functional unit.

While some solutions to the above problem do exist, there still remains a need for a simple yet effective solution for television commercial detection. A simple solution would require minimal hardware and time to implement, reducing manufacturing costs during assembly. Also, it potentially would be applicable to a wider range situations and television viewing environments, allowing anyone in the world the same accessibility in detecting commercials.

### SUMMARY

One objective of the claimed invention is therefore to provide a method for detecting television commercials, to solve the above-mentioned problem.

According to an exemplary embodiment of the claimed invention, a method for detecting a program deviation period during a television broadcast having a main audio program and a secondary audio program is disclosed. The method comprises: receiving the main audio program; receiving the secondary audio program; converting the main audio program and the secondary audio program into a main channel and a secondary channel; calculating a similarity value between the main channel and the secondary channel within a candidate period; and determining whether the candidate period is the program deviation period according to the calculated similarity value.

According to another exemplary embodiment of the claimed invention, a system for detecting a program deviation period during a television broadcast having a main audio program and a secondary audio program is disclosed. The system comprising: a tuner for receiving the main and secondary audio programs in the television broadcast and converting into a main channel and a secondary channel; a comparator coupled to the main channel and the secondary channel for calculating a similarity value between the main channel and the secondary channel within a candidate period; and a decision unit coupled to the comparator for determining whether the candidate period is the program deviation period according to the calculated similarity value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a commercial detection unit according to the prior art.

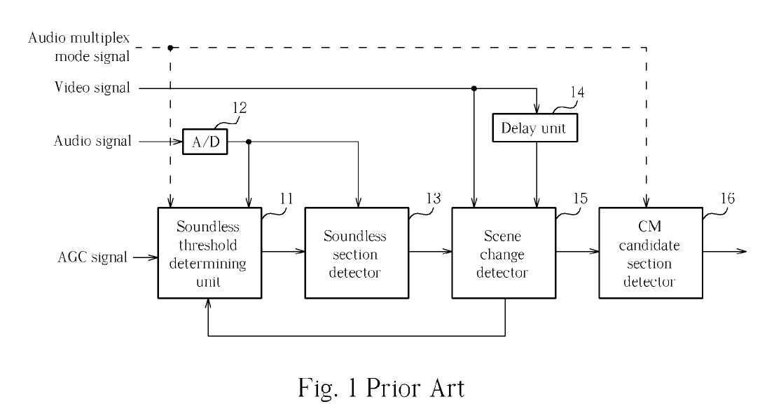

FIG. 2 illustrates a typical analog audio stream spectrum provided with a television broadcast signal.

FIG. 3 illustrates an exemplary embodiment of the system for detecting a program deviation period during a television broadcast having a main audio program and a secondary audio program according to the present invention.

FIG. 4 illustrates a method for detecting a program deviation period during a television broadcast having a main audio program and a secondary audio program according to an exemplary embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

One objective of the present invention is therefore to provide a simple, yet effective solution for detecting program deviation periods. Program deviation periods may not only comprise television commercials, but may comprise other items that may deviate a viewer from watching their desired show (notice or emergency bulletins, programming conflicts, etc.). The present invention operates on the basis of distinguishing between a main audio channel, and its secondary audio channel to determine a current program deviation period.

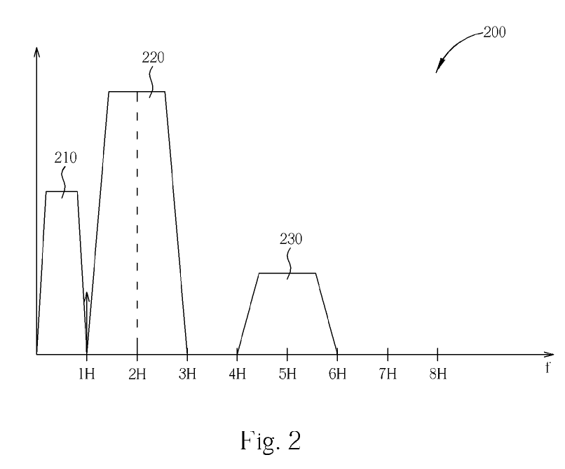

FIG. 2 illustrates a typical analog audio stream spectrum 200 provided with a television broadcast signal. When watching a television broadcast, the audio spectrum 200 accompanies the sent video signal to provide full audio-video data to a viewer. The audio spectrum 200 always includes a main audio program 210, comprising the spoken text/dialogue of the viewed program usually in a native language of the broadcast. The main audio program 210 is usually monaural, provided in FM and having sound for only one channel. In some embodiments, the audio spectrum 200 additionally includes a stereo channel 220, which is provided in AM, and contains sound for two channels (left and right). A secondary audio program 230 (or SAP) is also available, which provides another audio channel different from the main audio program 210. The secondary audio program 230 usually provides spoken dialogue or sound in an alternative language to the main audio program 210, but may be used for other purposes as well.

The present invention below makes use of both the main audio program 210 and the secondary audio program 230 (when available) in order to determine if there is currently a program deviation period playing. While watching a television program having two audio programs, a tuner receives the main audio program 210 and the secondary audio program 230, and a demodulator converts the audio programs 210 and 230 into a main channel and a secondary channel. The main and secondary channels are sometimes the left and right audio channels. In a program deviation period, the secondary audio program 230 may not be existed, and the content of the secondary channel may be copied from the main channel, resulting the two channels share many similarities. However, when playing the television program, many differences between the two channels occurred. One such example is the spoken language. While watching a normal program, the main audio program 210 provides dialogue in a first language, while the secondary audio program 230 provides dialogue in a second language (different from the first language). However, during the program deviation period, the secondary audio program 230 is usually absent, as commercials and such are seldom translated into the second language. Therefore, having the main channel and secondary channel obtained by demodulation concurrently playing the same language of spoken text may be an indication of a current program deviation period.

Other characteristics to determine similarities between the main channel and secondary channel may include: correlation between the two channels, difference of frequency ranges between the two channels, and text translation of spoken dialogue between the two channels. Although a limited number of examples for determining similarities between a main channel and secondary channel are presented above, the present invention is not limited to solely these examples. In fact, any potential characteristic to distinguish or comparatively gauge differences between the main channel and secondary channel may be utilized provided that the teachings of the present invention remain intact.

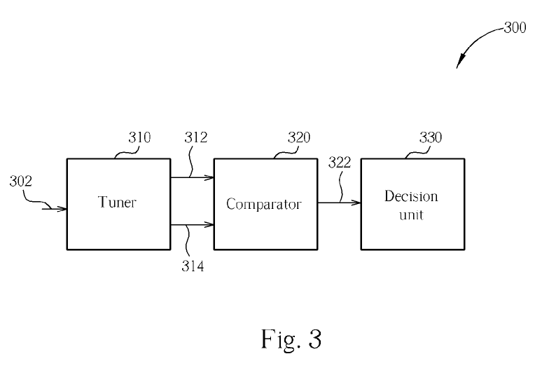

FIG. 3 illustrates an exemplary embodiment of a system 300 for detecting a program deviation period during a television broadcast having a main audio program and a secondary audio program, according to the present invention. The system comprises a tuner 310, a comparator 320 and a decision unit 330. Operation of the system 300 is further detailed below.

An RF television broadcast signal 302 is inputted to, and received by the tuner 310. The tuner tunes the broadcast signal 302 to a desired input television channel selected by a viewer (not shown). Upon tuning to the desired television channel, the tuner 310 demodulates and provides the main channel 312 and the secondary channel 314 corresponding to the video program of the desired television channel. According to a desired embodiment of the present invention, the two channels may be simultaneously provided, or have a time/phase delay between them.

The comparator 320 is coupled to the main channel 312 and the secondary channel 314, and calculates a similarity value 322 between the main channel 312 and the secondary channel 314 within a candidate period. As eluded to above, the similarity value 322 can be determined according to a correlation between the two audio channels, a language of the main channel 312 and a language of the secondary channel 314, or a frequency range of the channel 312 and a frequency range of the secondary channel 314. The candidate period is just a sample timeframe from which the similarity value 322 is gauged. A duration or length of the candidate period can vary according to different embodiments of the present invention, according to a desired sampling resolution of the similarity value calculation.

A decision unit 330 is coupled to the comparator, and determines whether the candidate period is the program deviation period according to the calculated similarity value 322. The determination additionally depends on the way in which the similarity value 322 was calculated. For instance, in a certain embodiment of the present invention, if the similarity value 322 is determined according to a language of the main channel 312 and a language of the secondary channel 314, then the candidate period corresponds to the program deviation period when the language of the main channel matches the language of the secondary channel.

In another embodiment of the present invention, If the similarity between the main channel 312 and the secondary channel 314 is performed according to a frequency range of the channel 312 and a frequency range of the secondary channel 314, then the candidate period corresponds to the program deviation period when the frequency range of the main channel 312 is within a predetermined limit of the frequency range of the secondary channel 314.

Also, the candidate period can be found corresponding to the program deviation period when the main channel exactly matches the secondary channel in yet another embodiment of the present invention.

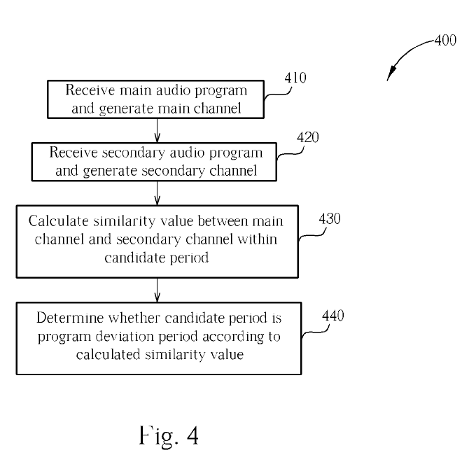

A method 400 for detecting a program deviation period during a television broadcast having a main audio program and a secondary audio program is also disclosed in FIG. 4. Provided that substantially the same result is achieved, the steps of the process 400 need not be in the exact order shown and need not be contiguous, that is, other steps can be intermediate. The method 400 comprises:
Step 410: Receive the main audio program and generate a main channel.
Step 420: Receive the secondary audio program and generate a secondary channel.
Step 430: Calculate a similarity value between the main channel and the secondary channel within a candidate period.
Step 440: Determine whether the candidate period is the program deviation period according to the calculated similarity value.

By calculating a similarity value between the main channel and the secondary channel to determine differences in their characteristics, the present invention is able to determining whether a program deviation period is currently playing, based to the calculated similarity value. This provides a simple, yet cost and design efficient solution for detection of commercials and other programs which deviate a viewer from their regularly viewed programs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for detecting a program deviation period during a television broadcast having a main audio program and a secondary audio program, the method comprising:
receiving the main audio program;
receiving the secondary audio program;
converting the main and secondary audio programs into a main channel and a secondary channel;
calculating a similarity value between the main channel and the secondary channel within a candidate period; and
determining whether the candidate period is the program deviation period according to the calculated similarity value.

2. The method of claim 1 wherein calculating the similarity value between the main channel and the secondary channel is performed according to a correlation between the main channel and the secondary channel.

3. The method of claim 1 wherein calculating the similarity value between the main channel and the secondary channel is performed according to a language of the main channel and a language of the secondary channel.

4. The method of claim 3 wherein the candidate period corresponds to the program deviation period when the language of the main channel matches the language of the secondary channel.

5. The method of claim 1 wherein calculating the similarity value between the main channel and the secondary channel is performed according to a frequency range of the main channel and a frequency range of the secondary channel.

6. The method of claim 5 wherein the candidate period corresponds to the program deviation period when the frequency range of the main channel is within a predetermined limit of the frequency range of the secondary channel.

7. The method of claim 1, wherein the main audio program and the secondary audio program are simultaneously received.

8. The method of claim 1 wherein the candidate period corresponds to the program deviation period when the main channel matches the secondary channel.

9. The method of claim 1 wherein the program deviation period is a commercial.

10. A system for detecting a program deviation period during a television broadcast having a main audio program and a secondary audio program, the system comprising:
a tuner for receiving the main and secondary audio programs and converting the audio programs into the main channel and the secondary channel;
a comparator coupled to the main channel and the secondary channel for calculating a similarity value between the main channel and the secondary channel within a candidate period; and
a decision unit coupled to the comparator for determining whether the candidate period is the program deviation period according to the calculated similarity value.

11. The system of claim 10 wherein the comparator is further for calculating the similarity value between the main channel and the secondary channel according to a correlation between the main channel and the secondary channel.

12. The system of claim 10 wherein the comparator is further for calculating the similarity value between the main channel and the secondary channel according to a language of the main channel and a language of the secondary channel.

13. The system of claim 12 wherein the decision unit is for determining that the candidate period is the program deviation period when the language of the main channel matches the language of the secondary channel.

14. The system of claim 10 wherein the comparator is further for calculating the similarity between the main channel and the secondary channel according to a frequency range of the main channel and a frequency range of the secondary channel.

15. The system of claim 14 wherein the decision unit is for determining that the candidate period is the program deviation period when the frequency range of the main channel is within a predetermined limit of the frequency range of the secondary channel.

16. The system of claim 10, wherein the tuner simultaneously generates the main channel and the secondary channel.

17. The system of claim 10 wherein the decision unit is for determining that the candidate period is the program deviation period when the main channel matches the secondary channel.

18. The system of claim 10 wherein the program deviation period is a commercial.
